(19) United States
(12) Patent Application Publication
(10) Pub. No.: US 2012/0280519 A1
(43) Pub. Date: Nov. 8, 2012

(54) HOOD LATCH FOR VEHICLE

(75) Inventor: Ji Young Hong, Hwaseong-si (KR)

(73) Assignee: Hyundai Motor Company, Seoul (KR)

(21) Appl. No.: 13/292,743

(22) Filed: Nov. 9, 2011

(30) Foreign Application Priority Data
May 4, 2011 (KR) 10-2011-0042229

(51) Int. Cl. E05C 19/12

(52) U.S. Cl. 292/128

(57) ABSTRACT

A hood latch assembly for a vehicle may include a base provided under an upper cover of a hood in the vehicle, a main hook pivotally coupled to the base, a rotary member pivotally coupled to the base by a first hinge supported by a first elastic member and having an auxiliary hook disposed above the main hook, wherein the auxiliary hook latches or releases a striker depending on rotation angle of the rotary member, and a release knob rotatably coupled to the rotary member by a second hinge supported by a second elastic member, wherein the release knob has on a first end thereof a pressing part to press and rotate the rotary member when the release knob rotates in one direction.

### CROSS-REFERENCE TO RELATED APPLICATIONS

The present application claims priority to Korean Patent Application No. 10-2011-0042229 filed on May 4, 2011, the entire contents of which is incorporated herein for purposes by this reference.

### BACKGROUND OF THE INVENTION

1. Field of the Invention

The present invention relates to a hood latch for a vehicle which is configured such that, when a hood pops up, a release knob is interlocked with a striker and exposed out of an upper cover.

2. Description of Related Art

Generally, to open a hood for a vehicle, a user manipulates an indoor release switch to primarily pop up the hood to a predetermined degree and then inserts his/her hand into the hood before pulling a release knob to completely release the hood.

In the case of such a pop-up structure for a hood, a predetermined gap must be maintained between a hood panel and a latch knob due to design conditions that take into account over-travel and moving gap when the hood is closed. However, because of a recent design trend related to the upper separation of the hood, the space given to manipulate the latch knob has been reduced. Therefore, a degree to which the latch knob protrudes from the upper cover surface is reduced, thus inconveniencing the user when manipulating the latch knob to open the hood.

FIG. 1 is a view showing a representative example of a conventional hood latch for a vehicle. The hood latch is covered with an upper cover (not shown) of a front end of the hood. The conventional hood latch includes a main hook 20 and an auxiliary hook 32 rotatably coupled to base 10. The hood latch is operated in such a way that a striker (not shown) is primarily released from the main hook 20 by manipulating an indoor release switch (not shown). Thereafter, the user inserts his/her hand into the upper cover and pulls a handle 42 of a release knob 40. Then, a rotary member 30 of the auxiliary hook 32 rotates around a hinge 44 so that the striker is completely released. Subsequently, the rotary member 30 is returned to its original position by a spring.

However, in the conventional hood latch having the above-mentioned construction, as stated above, because of a design trend to increase the upper cover, even when the strike is primarily released from the main hook 20, the release knob 40 is still covered by the upper cover rather than being exposed upwards from the upper cover. Due to this structure, it is inconvenient for the user to locate the release knob 40 and pull it. Therefore, a technique is required in which when the hood primarily pops up, the release knob 40 is exposed upwards from the upper cover, and when the hood is closed, the release knob 40 is retracted to its original position, thus making it easy to open and close the hood.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hood latch for a vehicle which is configured such that when the hood pops up, a release knob is exposed out of an upper cover, and when the hood is closed, the release knob is retracted into the upper cover again, thus increasing the degree of design freedom of the hood, and solving the problem of the conventional art that inconvenienced a user.

In an aspect of the present invention, the hood latch assembly for a vehicle, may include a base provided under an upper cover of a hood in the vehicle, a main hook pivotally coupled to the base, a rotary member pivotally coupled to the base by a first hinge supported by a first elastic member and having an auxiliary hook disposed above the main hook, wherein the auxiliary hook latches or releases a striker depending on rotation angle of the rotary member, and a release knob rotatably coupled to the rotary member by a second hinge supported by a second elastic member, wherein the release knob may have on a first end thereof a pressing part to press and rotate the rotary member when the release knob rotates in one direction.

The main hook is interlocked with an indoor release switch to latch or release the striker depending on rotation of the main hook, and the release knob may include a handle extending from a second end thereof towards the upper cover.

When the striker is hooked to the main hook, the release knob is restrained from moving upwards by the striker, so that the handle is located under the upper cover, and when the striker is released from the main hook, the release knob is rotated in the one direction about the second hinge supported by the second elastic member, so that the handle is exposed upwards from the upper cover.

The rotary member may have a stopper corresponding to the pressing part of the release knob so that a rotation of the release knob is limited to a predetermined angle.

The second elastic member of the release knob applies an elastic force to the release knob such that the release knob is biased in the one direction, and the first elastic member of the rotary member applies an elastic force to the rotary member such that the rotary member is biased in the other direction, wherein the base may have a stopper and an end of the rotary member is selectively locked thereby so as to restrain the rotary member from rotating in the other direction.

The rotary member may have a stopper corresponding to the pressing part of the release knob so that a rotation of the release knob is limited to a predetermined angle.

An elastic force of the first elastic member in the rotary member is set to be greater than an elastic force of the second elastic member in the release knob so that when the pressing part of the release knob is brought into contact with the stopper of the rotary member, elastic rotation of the release knob in the other direction is stopped.

The first hinge supported by the first elastic member of the rotary member may include a spring having a first end supported by the rotary member, and a second end supported by the stopper of the base, and a hinge pin hingedly-coupled the rotary member to the base, and the second hinge supported by the second elastic member of the release knob may include a spring having a first end supported by the release knob, and a second end supported by the stopper of the rotary member, and a hinge pin hingedly-coupled the release knob to the rotary member.

In another aspect of the present invention, a hood latch assembly for a vehicle may include a base provided under an upper cover of a hood in the vehicle, a main hook pivotally coupled to the base, the main hook being interlocked with an indoor release switch to latch or release a striker depending on rotation of the main hook, a rotary member pivotally coupled to the base by an elastic member and having an auxiliary hook disposed above the main hook, the auxiliary hook latching or releasing the striker depending on rotation angle of the rotary member, and a release knob pivotally coupled to the rotary member by an elastic member, the release knob having on a first end thereof a pressing part pressing and rotating the rotary member when the release knob rotates in a direction, with a handle extending from a second end of the release knob towards the upper cover.

In further another aspect of the present invention, a hood latch assembly for a vehicle may include a base provided under an upper cover of a hood in the vehicle, a rotary member elastically and pivotally coupled to the base and having an auxiliary hook disposed above a main hook, the main hook being interlocked with an indoor release switch to latch or release a striker depending on rotation of the main hook, the auxiliary hook secondarily latching or releasing the striker depending on rotation of the rotary member, and a release knob elastically and pivotally coupled to the base or the rotary member, the release knob having on a first end thereof a pressing part to press and rotate the rotary member, with a handle extending from a second end of the release knob towards the upper cover.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a hood latch for a vehicle according to a conventional art.

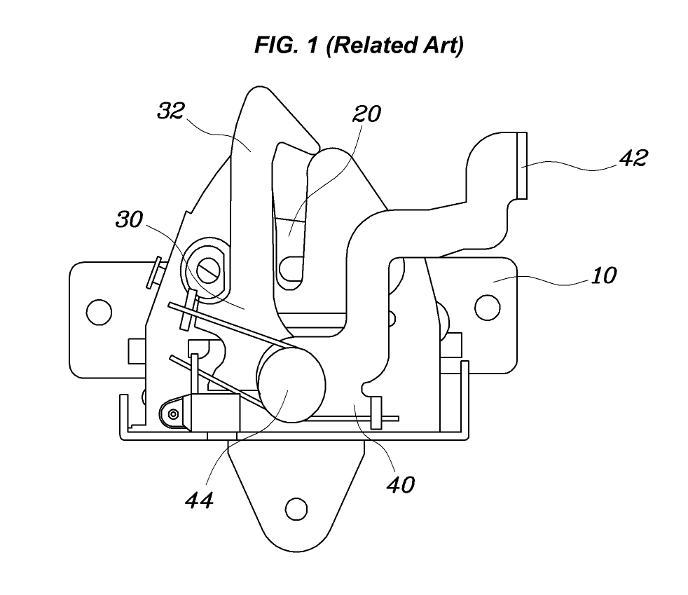

FIG. 2 is a perspective view illustrating a first stage of the operation of a hood latch for a vehicle, according to an exemplary embodiment of the present invention.

FIG. 3 is a front view of the hood latch of FIG. 2.

FIG. 4 is a perspective view illustrating a second stage of the operation of the hood latch according to the exemplary embodiment of the present invention.

FIG. 5 is a front view of the hood latch of FIG. 4.

FIG. 6 is a perspective view illustrating a third stage of the operation of the hood latch according to the exemplary embodiment of the present invention.

FIG. 7 is a front view of the hood latch of FIG. 6.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a hood latch for a vehicle according to an exemplary embodiment of the present invention will be described in detail with reference to the attached drawings.

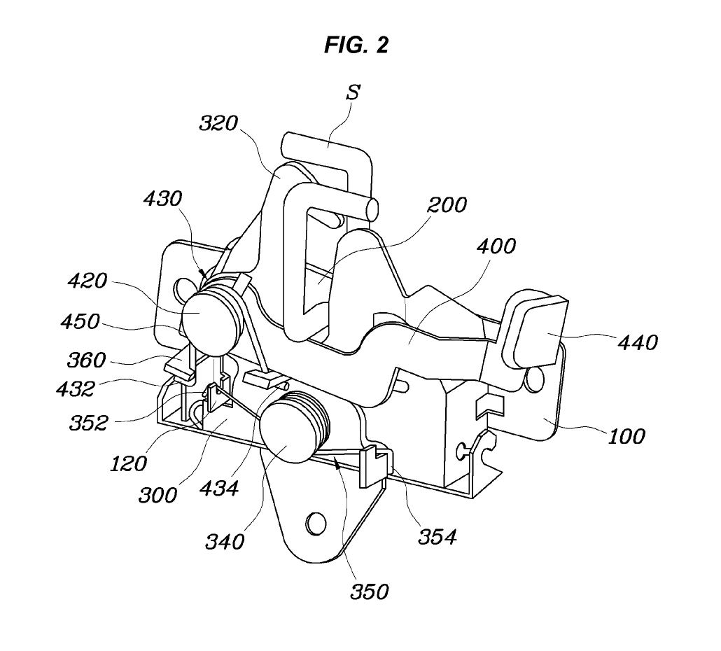

FIGS. 2 through 7 illustrate the operation of the hood latch according to the exemplary embodiment of the present invention which is divided into a first stage, a second stage and a third stage. The hood latch according to the exemplary embodiment of the present invention will be described in detail with reference to FIGS. 2 through 7. The hood latch includes a base 100, a main hook 200, a rotary member 300 and a release knob 400. The base 100 is provided under an upper cover of a hood in the vehicle. The main hook 200 is mounted to the base 100 and is interlocked with an indoor release switch to latch or release a striker S depending on rotation of the main hook 200. The rotary member 300 is provided on the base 100 and has an auxiliary hook 320 which is disposed above the main hook 200. The auxiliary hook 320 secondarily latches or releases the striker S depending on rotation of the rotary member 300. The release knob 400 is coupled to the rotary member 300 by a hinge supported by an elastic member. The release knob 400 has on a first end thereof a pressing part 450 which presses and rotates the rotary member 300 when the release knob 400 rotates in a corresponding direction. A handle 440 extends from a second end of the release knob 400 towards the upper cover.

In another embodiment, a hood latch according to an exemplary embodiment of the present invention includes a base 100, a main hook 200, a rotary member 300 and a release knob 400. The base 100 is provided under the upper cover of the hood of the vehicle. The main hook 200 is mounted to the base 100 and is interlocked with the indoor release switch to latch or release the striker S depending on rotation of the main hook 200. The rotary member 300 is provided on the base 100 and has an auxiliary hook 320 which is disposed above the main hook 200. The auxiliary hook 320 secondarily latches or releases the striker S depending on rotation of the rotary member 300. The release knob 400 is coupled to the base 100 by a hinge supported by an elastic member. The release knob 400 has on a first end thereof a pressing part 450 which presses and rotates the rotary member 300 when the release knob 400 rotates in a corresponding direction. A handle 440 extends from a second end of the release knob 400 towards the upper cover. That is, the release knob 400 may be coupled to the base 100, rather than to the rotary member 300, by the hinge supported by an elastic member.

In a further embodiment, a hood latch according to an exemplary embodiment of the present invention includes a base 100, a rotary member 300 and a release knob 400. The base 100 is provided under the upper cover of the hood of the vehicle. The rotary member 300 is provided on the base 100 and has an auxiliary hook 320. The auxiliary hook 320 is disposed above a main hook 200 that is interlocked with the indoor release switch to latch or release the striker S depending on rotation of the main hook 200. The auxiliary hook 320 secondarily latches or releases striker S depending on rotation of the rotary member 300. The release knob 400 is coupled to the base 100 or the rotary member 300 by a hinge supported by an elastic member. The release knob 400 has on a first end thereof a pressing part 450 which presses and rotates the rotary member 300 when the release knob 400 rotates in a corresponding direction. A handle 440 extends from a second end of the release knob 400 towards the upper cover. In other words, the hood latch may be configured such that the main hook 200 is coupled to a part of the vehicle body rather than to the base 100.

The second embodiment and the third embodiment have the same core technique as that of the first embodiment. Therefore, the hook latch of the present invention will be described in detail using the first embodiment as a basis therefor.

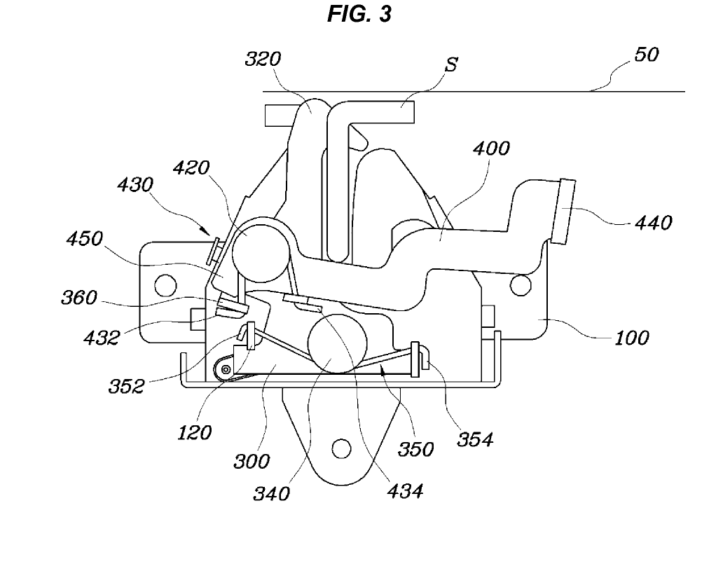

FIGS. 2 and 3 illustrate a first stage of the operation of the hood latch according to the exemplary embodiment of the present invention. The base 100 is provided under the upper cover of the hood of the vehicle. The main hook 200 is coupled to the base 100. The main hook 200 is interlocked with the indoor release switch by a wire and related other devices. Thus, depending on rotation of the main hook 200, the striker S is latched to or released from the main hook 200.

The rotary member 300 is also coupled to the base 100. The rotary member 300 has the auxiliary hook 320 which is disposed above the main hook 200, so that the striker S is secondarily latched to or released from the auxiliary hook 320 depending on rotation of the rotary member 300. The release knob 400 is coupled to the rotary member 300 by the hinge supported by an elastic member. The pressing part 450 is provided on the first end of the release knob 400 so that when the release knob 400 rotates, the pressing part 450 presses the rotary member 300 to rotate it. The handle 440 which extends towards the upper cover is provided on the second end of the release knob 400.

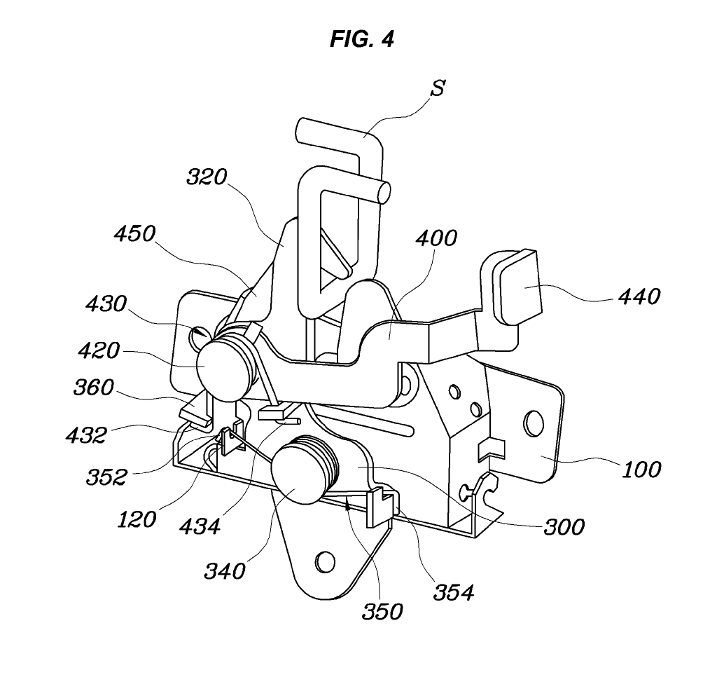

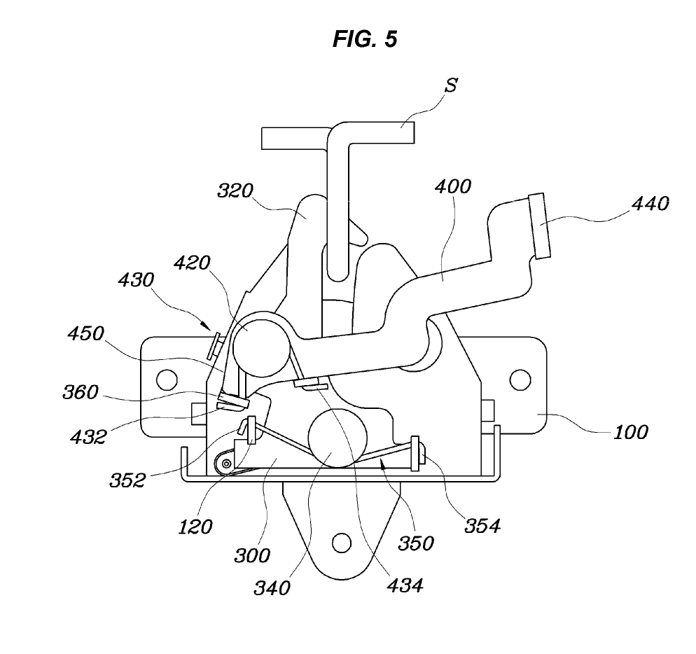

Furthermore, as shown in FIGS. 2 and 3, in the case where the striker S is hooked to the main hook 200, the release knob 400 is restrained from moving upwards by the striker S. Thus, the handle 440 is located under the upper cover. As shown in FIGS. 4 and 5, when the striker S is released from the main hook 200, the release knob 400 is rotated by the hinge supported by an elastic member in a counterclockwise direction, so that the handle 440 is exposed upwards from the upper cover.

In other words, when the hood is closed, the striker S is hooked to the main hook 200 and simultaneously presses the release knob 400 downwards. Thereby, the release knob 400 is contained inside the upper cover and thus does not impede the operation of latching the hood.

When a user operates the release switch, the main hook 200 releases the striker S. Then, as shown in FIGS. 3 and 4, striker S moves upwards, and the hood primarily pops up. The striker S is hooked to the auxiliary hook 320. Thereby, the release knob 400 is rotated in the counterclockwise direction so that the handle 440 of the release knob 400 is partially exposed upwards from the upper cover. Subsequently, when the user pulls the exposed handle 440 of the release knob 400, the release knob 400 and the rotary member 300 successively rotate so that the striker S is completely released from the auxiliary hook 320.

The rotary member 300 includes a stopper 360 which corresponds to the pressing part 450 of the release knob 400. The counterclockwise rotation of the release knob 400 is limited to a predetermined angular range by the stopper 360. That is, from the state of FIG. 2 to the state of FIG. 4, when the striker S is released, the force with which the striker S has pressed the release knob 400 is also released. Then, the release knob 400 is rotated in the counterclockwise direction along with the movement of the striker S. Here, because the stopper 360 corresponding to the pressing part 450 of the release knob 400 is provided on the rotary member 300, the rotation of the release knob 400 is limited to the predetermined angular range. Hence, the release knob 400 is stopped again at a predetermined position at which the handle 440 of the release knob 400 is partially exposed upwards from the upper cover. In this state, the user can easily discern the partially exposed handle 440 before pulling the handle 440 to open the hood.

Meanwhile, the rotary member 300 is also coupled to the base 100 by a hinge supported by an elastic member. The hinge supported by an elastic member of the release knob 400 applies elastic force to the release knob 400 such that the release knob 400 is biased in the counterclockwise direction. The hinge supported by an elastic member of the rotary member 300 applies elastic force to the rotary member 300 such that the rotary member 300 is biased in the clockwise direction. Furthermore, a stopper 120 may be provided on the base 100 to restrain the rotary member 300 from rotating in the clockwise direction.

In other words, the release knob 400 is always biased by elastic force in the counterclockwise direction but limited by the striker S. The rotary member 300 is always biased by elastic force in the clockwise direction but limited by the stopper 120 of the base 100.

Meanwhile, the stopper 360 corresponding to the pressing part 450 of the release knob 400 is provided on the rotary member 300. Further, the hinge supported by an elastic members are set in such a way that the elastic force of the hinge supported by an elastic member of the rotary member 300 is greater than that of the hinge supported by an elastic member of the release knob 400. Thus, when the pressing part 450 of the release knob 400 comes into contact with the stopper 360 of the rotary member 300, elastic rotation of the release knob 400 can be stopped. In detail, in the second stage of FIGS. 4 and 5, as the striker S is released from the main hook 200, the release knob 400 rotates in the counterclockwise direction. Here, the pressing part 450 of the release knob 400 is stopped by the stopper 360 of the rotary member 300 after the release knob 400 rotates by a predetermined angle. Because the elastic force applied to the release knob 400 is set such that it is less than the elastic force applied to the rotary member 300, the rotation of the release knob 400 is stopped so that only portion of the handle 440 is exposed upwards from the upper cover.

Meanwhile, the hinge supported by an elastic member of the release knob 400 includes a spring 430 and a hinge pin 420. The spring 430 has a first end 434 which is supported by the release knob 400, and a second end 432 which is supported by the stopper 360 of the rotary member 300. The hinge supported by an elastic member of the rotary member 300 includes a spring 350 and a hinge pin 340. The spring 350 includes a first end 354 which is supported by the rotary member 300, and a second end 352 which is supported by the stopper 120 of the base 100.

The operation of the hood latch having the above-mentioned construction will be explained in order. In the first stage (FIGS. 2 and 3), the hood is in the closed state. The striker S is latched to the main hook 200. The release knob 400 is pressed by the lower end of the striker S and thus prevented from rotating upwards. The handle 440 of the release knob 400 is completely covered with the upper cover.

In the second stage (FIGS. 4 and 5), when the user manipulates the release switch, the striker S is released from the main hook 200 and moved upwards before it is secondarily latched to the auxiliary hook 320 that is disposed above the main hook 200. The second stage pertains to a primary pop-up state of the hood. In this stage, as the striker S moves upwards a predetermined distance, the release knob 400 is rotated in the counterclockwise direction by the elastic force of the spring 430. When the pressing part 450 of the release knob 400 comes into contact with the stopper 360 of the rotary member 300, the rotation of the release knob 400 is stopped. Then, the handle 440 of the release knob 400 is partially exposed upwards from the upper cover.

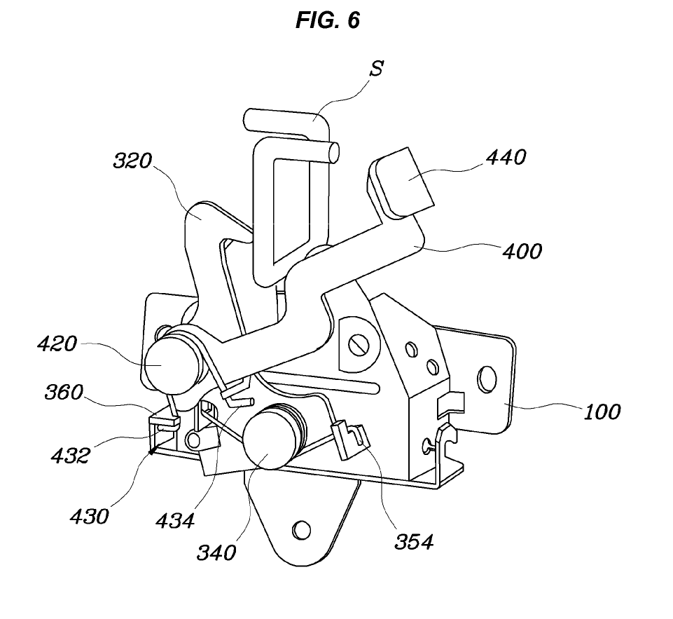

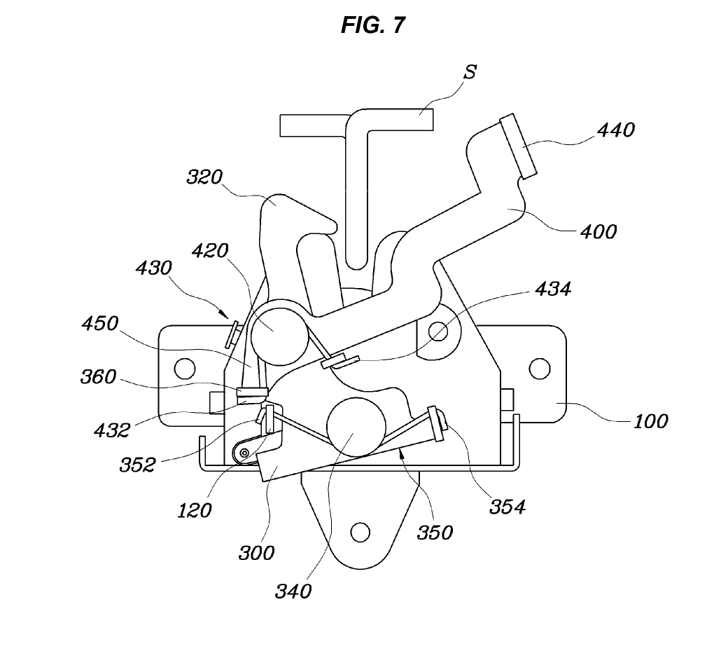

The third stage (FIGS. 6 and 7) pertains to when the user pulls the handle 440 of the release knob 400. In this stage, the release knob 400 rotates in the counterclockwise direction and compresses the stopper 360 of the rotary member 300. Thereby, the rotary member 300 overcomes the elastic force of the spring 350 and thus rotates in the counterclockwise direction. As a result, the striker S is completely released from the auxiliary hook 320. When the user releases the handle 440, the rotary member 300 is rotated in the clockwise direction by the spring 350, so that the release knob 400 is also rotated in the clockwise direction. Thus, the hook latch is returned to the state of the second stage. Meanwhile, when the user closes the hood, the striker S pushes the auxiliary hook 320 and the main hook 200 and then is latched to the main hook 200. The release knob 400 is pressed by the striker S while absorbing over-travel of the striker S. Thereby, the handle 440 of the release knob 400 is retracted into the upper cover.

As described above, in a hood latch of a vehicle according to an exemplary embodiment of the present invention, when the hood of the vehicle pops up, a release knob is partially exposed out of an upper cover. When the hood is closed, the release knob is completely retracted into the upper cover. Thus, the degree of design freedom of the hood can increase. Further, the problem of the conventional art that inconvenienced a user can be solved.

For convenience in explanation and accurate definition in the appended claims, the terms “upper” and “lower”, are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hood latch assembly for a vehicle, comprising:
a base provided under an upper cover of a hood in the vehicle;
a main hook pivotally coupled to the base;
a rotary member pivotally coupled to the base by a first hinge supported by a first elastic member and having an auxiliary hook disposed above the main hook, wherein the auxiliary hook latches or releases a striker depending on rotation angle of the rotary member; and
a release knob rotatably coupled to the rotary member by a second hinge supported by a second elastic member,
wherein the release knob has on a first end thereof a pressing part to press and rotate the rotary member when the release knob rotates in one direction.

2. The hood latch assembly as set forth in claim 1,
wherein the main hook is interlocked with an indoor release switch to latch or release the striker depending on rotation of the main hook; and
wherein the release knob includes a handle extending from a second end thereof towards the upper cover.

3. The hood latch assembly as set forth in claim 1, wherein
when the striker is hooked to the main hook, the release knob is restrained from moving upwards by the striker, so that the handle is located under the upper cover, and
when the striker is released from the main hook, the release knob is rotated in the one direction about the second hinge supported by the second elastic member, so that the handle is exposed upwards from the upper cover.

4. The hood latch assembly as set forth in claim 3, wherein the rotary member has a stopper corresponding to the pressing part of the release knob so that a rotation of the release knob is limited to a predetermined angle.

5. The hood latch assembly as set forth in claim 1, wherein the second elastic member of the release knob applies an elastic force to the release knob such that the release knob is biased in the one direction, and the first elastic member of the rotary member applies an elastic force to the rotary member such that the rotary member is biased in the other direction.

6. The hood latch assembly as set forth in claim 5, wherein the base has a stopper and an end of the rotary member is selectively locked thereby so as to restrain the rotary member from rotating in the other direction.

7. The hood latch assembly as set forth in claim 6, wherein the rotary member has a stopper corresponding to the pressing part of the release knob so that a rotation of the release knob is limited to a predetermined angle.

8. The hood latch assembly as set forth in claim 6, wherein an elastic force of the first elastic member in the rotary member is set to be greater than an elastic force of the second elastic member in the release knob so that when the pressing part of the release knob is brought into contact with the stopper of the rotary member, elastic rotation of the release knob in the other direction is stopped.

9. The hood latch assembly as set forth in claim 8, wherein the first hinge supported by the first elastic member of the rotary member includes:
a spring having a first end supported by the rotary member, and a second end supported by the stopper of the base; and
a hinge pin hingedly-coupled the rotary member to the base; and
the second hinge supported by the second elastic member of the release knob includes:
a spring having a first end supported by the release knob, and a second end supported by the stopper of the rotary member; and
a hinge pin hingedly-coupled the release knob to the rotary member.

10. A hood latch assembly for a vehicle, comprising:
a base provided under an upper cover of a hood in the vehicle;
a main hook pivotally coupled to the base, the main hook being interlocked with an indoor release switch o latch or release a striker depending on rotation of the main hook;
a rotary member pivotally coupled to the base by an elastic member and having an auxiliary hook disposed above the main hook, the auxiliary hook latching or releasing the striker depending on rotation angle of the rotary member; and
a release knob pivotally coupled to the rotary member by an elastic member, the release knob having on a first end thereof a pressing part pressing and rotating the rotary member when the release knob rotates in a direction, with a handle extending from a second end of the release knob towards the upper cover.

11. A hood latch assembly for a vehicle, comprising:
a base provided under an upper cover of a hood in the vehicle;
a rotary member elastically and pivotally coupled to the base and having an auxiliary hook disposed above a main hook, the main hook being interlocked with an indoor release switch to latch or release a striker depending on rotation of the main hook, the auxiliary hook secondarily latching or releasing the striker depending on rotation of the rotary member; and
a release knob elastically and pivotally coupled to the base or the rotary member, the release knob having on a first end thereof a pressing part to press and rotate the rotary member, with a handle extending from a second end of the release knob towards the upper cover.
